(19) United States
(12) Patent Application Publication
(10) Pub. No.: US 2011/0045431 A1
(43) Pub. Date: Feb. 24, 2011

(54) BONE SCREW LINKING DEVICE

(76) Inventors: Randall C. Groscurth, Troy, MI (US); Shoko U. Groscurth, Troy, MI (US)

Correspondence Address: Michael B. Stewart;Rader, Fishman & Grauer PLLC, 39533 Woodward Avenue, Suite 140, Bloomfield Hills, MI, 48304, US

(21) Appl. No.: 12/882,800

(22) Filed: Sep. 15, 2010

Related U.S. Application Data
(63) Continuation-in-part of application No. 12/620,851, filed on Nov. 18, 2009.
(60) Provisional application No. 61/311,511, filed on Mar. 8, 2010.
(60) Provisional application No. 61/115,874, filed on Nov. 18, 2008.
(60) Provisional application No. 61/270,942, filed on Jul. 15, 2009.

(51) Int. Cl. A61C 8/00; A61C 13/36

(52) U.S. Cl. 433/74; 433/174

(57) ABSTRACT

A dental device having a marker and a linking component configured to be inserted into a mouth. The dental device provides a temporary positioning reference location that may be collected in a tomography scan data set and surface scan data set. The dental device may be used to orient and verify the tomography scan data set and the surface scan data set to create a master dental file that may be used to determine the appropriate location of a dental implant.

### RELATED INVENTIONS

This application claims priority to U.S. Provisional Application No. 61/311,511 filed Mar. 8, 2010, and is a Continuation-in-Part of U.S. patent application Ser. No. 12/620,851 filed Nov. 18, 2009 which claims priority under 35 U.S.C. §119(e) from prior U.S. Provisional Patent Applications Ser. No. 61/115,874 filed Nov. 18, 2008 and Ser. No. 61/270,942 filed Jul. 15, 2009. All of the foregoing applications are incorporated by reference herein in their entireties.

### FIELD OF THE INVENTION

The field of the invention relates to dental devices and procedures associated with various data sets from imaging and other sources of information with respect to a particular patient's physiology in physical and/or digital form and for linking data sets of information gathered regarding a particular patient's physiology into a comprehensive digital format for virtual design/illustration and manufacturing of image scanning templates, surgical guides, implants, crowns, bridges, and/or templates with optional diagnostic components useful in determining a suitable course of treatment for the particular patient.

### BACKGROUND

Physical master dental models can be of medical, dental damaged edentulous, partial edentulous, dentulous or other facial anatomical areas. Physical master dental models provide very valuable information about soft tissues and very detailed surface contours with relationship to the dental anatomy of teeth and/or tissue. This very important information of the soft tissue contours and relationship to the teeth and bones is typically not transferred accurately and mostly not transferred at all.

Making a traditional imaging template is very labor intensive with many steps. For example, a known template can be made with the following steps: Step (A): (1) 3D physical model; (2) waxing missing teeth by hand; (3) waxing tissue and other missing parts by hand; (3) duplicating wax up model with a silicone duplicating material; (4) separating the model from the silicone mold; (5) mixing a dental plaster and pouring it into the silicone mold; (6) waiting for it to harden one hour or so; (7) separating this new model from the silicone mold; (8) vacuum- forming a suck down onto this duplicated model; (9) trimming this plastic suck down (template); (10) mixing a barium powder into an acrylic mixture of powder and liquid; (11) pouring this mixture into the plastic suck down (template); (12) placing the first model together with the barium/acrylic filled template; (13) curing this in a warm water bath under vacuum; (14) separating the model from the cured acrylic (which almost always results in a broken model); (15) cleaning up the template; (16) fitting the template on to the master model (if the original master model was broken then a new master model needs to be reproduced, which can happen more then once during the process.) Step (B); any denture manufacture system can be used to create a template, which again takes a great deal of time and labor. This is only for making the imaging template. The template produced is scanned independent from and excluding any data transfer from the 3D physical model previously prepared.

A problem with computerized tomography (CT) scan images, cone beam computerized tomography (CB CT) scan images, magnetic resonance imaging (MRI) scan images, and other 3D imaging devise images is commonly referred to as “image scatter”. With CT scanning, different material in the patient's mouth can create what is called scattering of the image. This makes it difficult for the doctor to visualize teeth and bone contours, and basic anatomy, as well as any other anomalies, when analyzing the scanned image. Many times this scatter makes the imaging data unreliable, inaccurate and unusable for a proper diagnostic tool. An example of image scatter creating dental materials can include metal fillings, gold crowns and fixed partials.

One known attempt to eliminate these problems includes making a vacuum-formed plastic template from a duplicated diagnostic model. This template contains 3 mm-6 mm diameter balls of radio opaque material suitable for CT scan, CB CT scan, and/or MRI scan in several locations on the inside surface of the template. The patient wears this template in the mouth during a CT scan, CB CT scan, and/or MRI scanning process. The same template is placed back onto the 3D physical model in which it was made. The model is also subjected to a CT scan, CB CT scan, and/or MRI scanning process. Data relating to the outside surface of the template is all that is obtained from these two CT scans, CB CT scans, and/or MRI scans. The two different scanned data files are then put together with computer aided design (CAD) type software. The two scanned data file are connected by the 3 mm-6 mm diameter balls of radio opaque material suitable for CT scan, CB CT scan, and/or MRI scans in several locations on the inside surface of the template. The pictures are put together by the software. If the CT scan data, CB CT scan data, and/or MRI scan data has a lot of scatter, then this information is replaced with the scanned template outside surface data. CT scan data, CB CT scan data, and/or MRI scan data does not provide data as clean and as accurate as surface scan data.

It has been found that the vacuum-formed plastic template itself adds a layer of inaccuracy. The nature of the material allows the template to flex causing distortions when making and removing it from the working model. Placing the template into the patient's mouth can cause flexing, molding and stretching of the template shape, which can vary depending on the anatomical surfaces that it is in contact with, e.g. mouth contours, teeth, and tissue. Teeth are mobile and move small amounts in many different directions independent of each other because of the periodontal membrane. Tissue is both soft and hard in the mouth which can be distorted differently, when the same amount of pressure is applied to it. Teeth and tissue being mobile in nature, an inaccurate template can actual distort the actual position of teeth and tissue. A bad fitting template also will leave open spaces or gaps in between teeth, tissue, and/or the template. The thickness of the template itself will add another layer of inaccuracy to the data.

Other known ways of matching CT model scans can include a separate CT scan and model scan being virtually connected. Small areas of teeth and tissue from both scan data files are selected and matched together. This process is problematic if the CT image has scatter, since attempts to match areas or points from the model scan may not work.

### SUMMARY

The linking components can include one or more of the following features singularly or in any combination: (1) an anchor or receptor having an aperture to be fixedly connected to a dental master model; (2) a fastening connector component to be removably connected to the anchor or receptor for supporting at least one of an optional spacer and/or an imaging marker; (3) an optional spacer, if required to space an imaging template from the dental master model; and (4) a scaled and shaped imaging marker to reduce and/or eliminate information detail loss due to scatter using suitable radio opaque material in components, thereby allowing replacement of information lost with scan of model or patient's mouth to clean up CT scan data, CB CT scan data, and/or MRI scan data.

In a dental device for performing a dental procedure relating to replacement of teeth including a particular mouth formation of a patient and an intended dental implant location with respect to the patient, the improvement including a scaled and shaped linking component including an elongate fastening connector component and a shaped imaging/scaling marker component made at least partially of radio opaque material engageable with the elongate fastening connector component allowing at least one of a surface imaging scanning and a tomography imaging scanning of the at least one linking component creating an identifiable imaging scan data link.

In a dental device for performing a dental procedure relating to replacement of teeth including a particular mouth formation of a patient and an intended dental implant location with respect to the patient, the improvement including a linkable model, and at least one scaled and shaped linking component to be supported by the linkable model allowing surface imaging of the linkable model and linking component to create an identifiable imaging scan data link.

In a dental device for performing a dental procedure relating to replacement of teeth including a particular mouth formation of a patient and an intended dental implant location with respect to the patient, the improvement including a linkable imaging template, and at least one scaled and shaped linking component made at least partially of a radio opaque material to be supported by the linkable imaging template linkable with respect to a linkable model allowing a tomography imaging scan of physiology of the patient with the linkable imaging template and the at least one scaled and shaped linking component supported by the linkable imaging template to create an identifiable imaging scan data link.

A process for performing a dental procedure relating to replacement of teeth including a particular mouth formation of a patient and an intended dental implant location with respect to the patient, the improvement including scaling, orienting and aligning data from different data acquisition sources with respect to one another based on imaging of the at least one scaled and shaped linking component made at least partially of radio opaque material existing in the data from the different data acquisition sources, and linking the scaled, oriented, and aligned data from different data acquisition sources into a master data file.

In a dental device for performing a dental procedure relating to replacement of teeth including a particular mouth formation of a patient and an intended dental implant location with respect to the patient, the improvement including a diagnostic model formed with computer aided manufacturing using a master data file including linked, scaled, oriented, and aligned data from different data acquisition sources and including at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device for performing a dental procedure relating to replacement of teeth including a particular mouth formation of a patient and an intended dental implant location with respect to the patient made by a process including forming a diagnostic model with computer aided manufacturing using a master data file including linked, scaled, oriented, and aligned data from different data acquisition sources, and forming at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device defining a positive likeness of part of an oral cavity of a particular patient for constructing a finished dental prosthesis for use in at least one procedure selected from a group consisting of diagnosis, therapeutic treatment planning, and surgery relating to a human being, the dental device including a diagnostic model with at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device defining a positive likeness of part of an oral cavity of a particular patient for constructing a finished dental prosthesis for use in at least one procedure selected from a group consisting of diagnosis, therapeutic treatment planning, and surgery relating to a human being, the dental device including virtually designing an imaging template with at least one linking component made at least partially of a radio opaque material, and printing the virtually designed template with a three dimensional printer.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified schematic diagram illustrating information linking mechanisms with linking components;

FIG. 2 is a perspective view of a linkable master dental model and impression having anchors and fastener connector components embedded in the master dental model and impression for linking the imaging components;

FIG. 3 is a detailed view of a linkable master dental model having apertures and linking anchors placed in the master dental model;

FIG. 4A is a perspective view of a plurality of between 3 mm-6 mm, inclusive, slotted, drilled, orientation ball and pin combinations associated with a hollow bone section diagnostic model;

FIG. 4B is a cross-sectional view of one of the between 3 mm-6 mm, inclusive, slotted, drilled, orientation ball and pin combinations associated with the hollow bone diagnostic model previously illustrated in FIG. 4A;

FIG. 5 is a side view of a set of linking components including a fastening connector component with scaling lines, an imaging/scaling marker, an optional spacer, anchor, imaging template, and dental model;

FIG. 6 is a side view of a set of linking components including a fastening connector screw, an imaging/scaling marker of radio-opaque material shaped as a sphere, an optional spacer, an anchor, an imaging template and a dental model;

FIG. 7 is a side view of a set of linking components including a fastening connector component, an imaging/scaling marker of radio-opaque material shaped as a tube in a variety of lengths, an optional spacer, an anchor, an imaging template, and a dental model;

FIGS. 8A-8C are illustrations of shaped mapping or linking pins made at least partially of radio opaque materials for use in CT scans, CB CT scans, and/or MRI scans and three-dimensional surface scanning or other scanning devices including positioning pins, orientation and/or scaling pins and radio opaque material pin tubes to be fit over the positioning pins, orientation and/or scaling pins with anchors;

FIGS. 9A-9B are a perspective views of a linkable imaging template formed on a linkable master dental model with fastening connector component and anchors;

FIG. 10A is a perspective view of a master dental model having an exposed underlying bone portion that can be covered by a removable tissue portion shown in FIG. 10B;

FIG. 10B is an exploded perspective view of a master dental model having a removable tissue portion removed to expose an internal removable bone structure portion;

FIG. 11 is a perspective view of a diagnostic model with bordered tissue and tissue veneer plus facial veneer diagnostic component;

FIG. 12A is a perspective view of a diagnostic model having an at least partially exposed bone portion and a facial veneer diagnostic component of an interior surface of teeth to be implanted;

FIGS. 12B-12C are perspective views of a diagnostic model having an at least partially exposed bone portion and a facial veneer diagnostic component of an exterior surface of teeth to be implanted;

FIG. 13A is a simplified cross sectional detail of a diagnostic model with exposed bone structure portion and visualization portions including a major nerve, an artery, a tooth nerve, a tooth blood vessel, a major nerve ending, a tooth root canal, a tooth pulp canal, a tooth root, a tooth nerve ending, bone density, and removable gum tissue; and

FIG. 13B is a simplified cross sectional side view of a diagnostic model with exposed bone structure portion, a removable gum tissue, and visualization portions including a tooth root, a tooth nerve, a tooth blood vessel, a main nerve, a main artery, a sinus cavity, a removable bone structure, and diagnostic teeth.

FIG. 14 illustrates an exemplary dental device.

FIG. 15 illustrates an exploded view of an exemplary dental device having a snap-on marker.

FIG. 16 illustrates an exploded view of an exemplary dental device having a screw-on marker.

FIG. 17 illustrates an exploded view of an exemplary dental device having an alternative illustrative screw-on marker.

FIG. 18 illustrates a dental device of the type disclosed in FIGS. 14 through 17 disposed in a patient's mouth.

FIG. 19 illustrates a dental appliance supported by a dental device of the type illustrated in FIGS. 14 through 18.

FIG. 20 illustrates a dental coping disposed on a dental device of the type illustrated in FIGS. 14 through 19.

FIG. 21 illustrates a dental coping embedded in a dental impression.

FIG. 22 is a system of using a dental device of the type illustrated in FIGS. 14 through 18.

### DETAILED DESCRIPTION

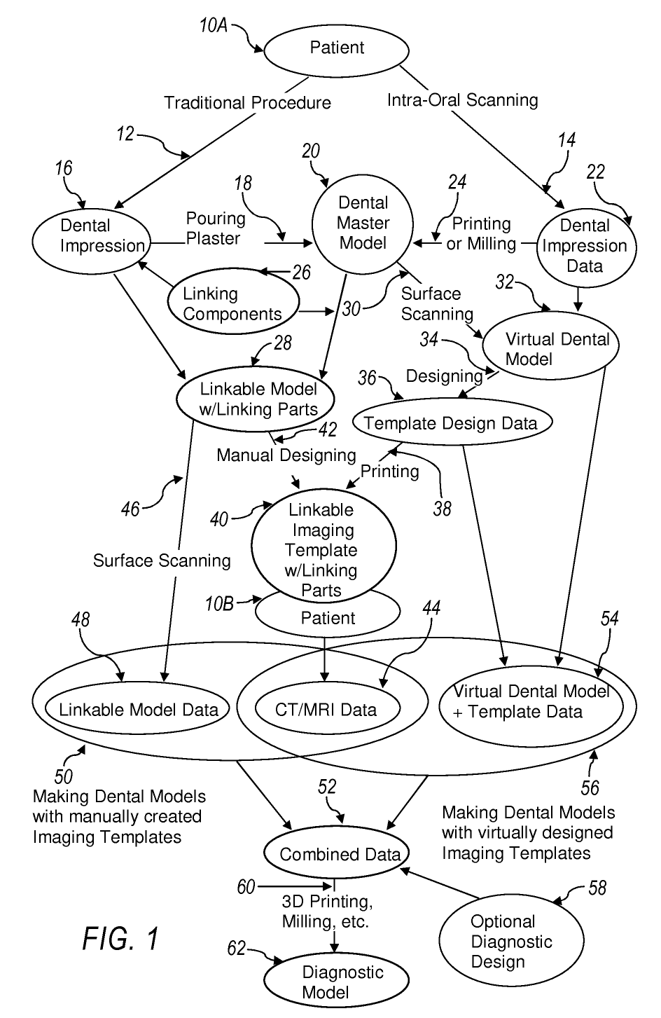

Referring now to FIG. 1, a simplified schematic diagram illustrating information linking mechanisms with linking components starts with a particular patient at a first point in time 10A undergoing either a traditional procedure 12 or an intra-oral scanning 14. The traditional procedure 12 includes a dental impression 16, pouring plaster 18 to create a dental master model 20. The intra-oral scanning 14 includes dental impression data 22, printing or milling 24 to create a dental master model 20. Linking components 26 can be associated with the dental impression 16 and the dental master model 20 to define a linkable model with linking parts 28. The linking components 26 can be used to create an identifiable imaging scan data link in common with both surface scan data files and tomography scan data files. The dental master model 20 can be surface scanned 30 to create a surface scan data file or the dental impression data can be inverted to provide a virtual dental model 32. Template design data 36 can be designed 34 with the virtual dental model 32. The template design data 36 can be used for printing 38 a linkable imaging template with linking parts 40. The linkable model with linking parts 28 can be used for manual designing 42 a linkable imaging template with linking parts 40. The linkable imaging template with linking parts 40 can be positioned in an oral cavity of the particular patient at a second point in time 10B to obtain tomography imaging scan data 44, by way of example and not limitation such as computerized tomography (CT) imaging scan data, cone beam computerized tomography (CB CT) imaging scan data, and magnetic resonance imaging (MRI) scan data, which are collectively referred to hereinafter generically as “tomography imaging scan data” 44. The linkable model with linking parts 28 including imaging/scaling markers can be surface scanned 46 to obtain a surface scan data file or linkable model data 48. The linkable model data 48 and tomography imaging scan data 44, collectively referred to as data sets 50, can be scaled, aligned, and oriented using the linking components 26 to create a combined data set 52 where dental models were made with manually created imaging templates. The virtual dental model 32 and the template design data 36 can be combined to provide virtual dental model+template data 54. The tomography imaging scan data 44 and virtual dental model+template data 54, collectively referred to as data sets 56, can be scaled, aligned, and oriented using the linkable imaging template with linking parts 40 printed 38 from the template design data 36 to create a combined data set or master data file 52 where dental models were made with virtually designed imaging templates. A master data file can be created from linked and scaled data from different data acquisition sources including at least one data acquisition source procedure selected from a tomography scan group consisting of CT image scanning the patient with a template having at least one scaled and shaped linking component, CB CT image scanning the patient with a template having at least one scaled and shaped linking component, MRI image scanning the patient with a template having at least one scaled and shaped linking component, and at least one data acquisition source procedure selected from a surface scan group consisting of intra-oral surface scanning the having at least one scaled and shaped linking component virtually placed on the data file, optical image scanning a linkable model having at least one scaled and shaped linking component, laser image scanning a linkable model having at least one scaled and shaped linking component, and surface scanning a linkable model having at least one scaled and shaped linking component. Optional diagnostic design data 58 can be incorporated into the combined data set or master data file 52. The optional diagnostic design 58 can include at least one of a fixed diagnostic component and a removable diagnostic component connected to the diagnostic model. The combined data set or master data file 52 can be used for three-dimensional (3D) printing or milling 60 of a diagnostic model 62 for performing a dental procedure relating to replacement of teeth including a particular mouth formation of a patient and an intended dental implant location with respect to the patient, where the diagnostic model 62 defines a positive likeness of at least part of an oral cavity of a particular patient for constructing a finished dental prosthesis for use in at least one procedure selected from a group consisting of diagnosis, therapeutic treatment planning, and surgery relating to a human being. The diagnostic model can be manufactured by three-dimensional printed structures made from a transparent material allowing internal three-dimensional printed structures corresponding to at least one of bone density, a root contour of a tooth, a nerve channels, a major nerve, a major nerve ending, internal bone structure, a tooth nerve, a tooth nerve ending, a tooth blood vessel, a tooth root canal, a tooth pulp canal, a blood vessel, an artery, and a sinus cavity to be made visible.

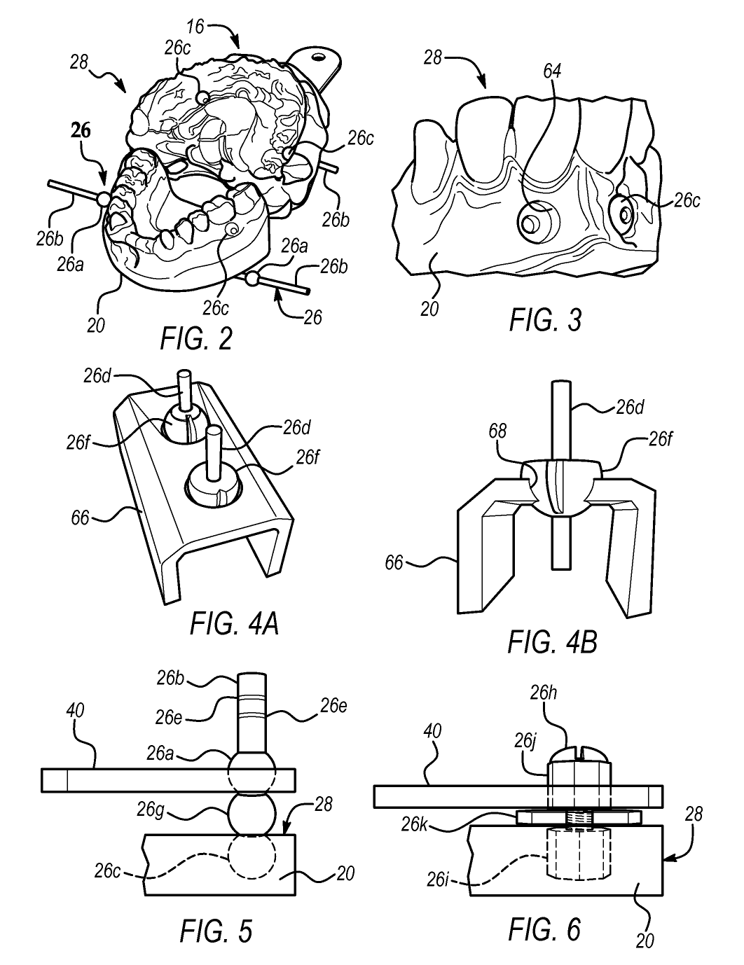

Referring now to FIG. 2, starting from a dental impression 16, a linkable model with linking parts 28, such as linking components 26, can be processed. The linking components 26 can include, by way of example and not limitation, anchors 26c and fastening connector components 26b placed within the dental impression 16 prior to pouring the model material into the impression to embed the anchors 26c within the linkable model with linking parts 28. Imaging/scaling marker 26a can be positioned on the fastening connector components 26b supported by the anchors embedded within the linkable model 28.

Alternatively, as illustrated in FIG. 3, starting from a dental master model 20, a linkable model with linking parts 28, such as linking components 26, can be processed. The dental master model 20 can be drilled subgingevally, lingually, facially or palatally in one or more locations. The diameter of the drilled apertures 64 corresponds with a diameter of desired anchors 26c. The linking components 26 can include, by way of example and not limitation, anchors 26c and fastening connector component 26b fixed within the drilled apertures 64 to embed the anchors 26c within the linkable model with linking parts 28.

Referring now to FIG. 5, a side view of a linking component including a fastening connector component 26b with scaling lines 26e is illustrated with a sphere-shaped anchor 26c embedded within a linkable model with linking parts 28. A radio-opaque imaging/scaling sphere-shaped marker 26a can be associated or fixed with respect to a linkable imaging template with linking parts 40. An optional spacer 26g can be located between an anchor 26c and an imaging/scaling sphere 26a, if desired.

Referring now to FIG. 6, a side view of a linking component including a fastening connector screw 26h is illustrated with a threaded anchor component 26i embedded within a linkable model with linking parts 28. A radio-opaque imaging/scaling marker component 26j can be associated or fixed with respect to a linkable imaging template with linking parts 40. An optional spacer 26k can be located between an anchor 26i and an imaging/scaling marker component 26j, if desired.

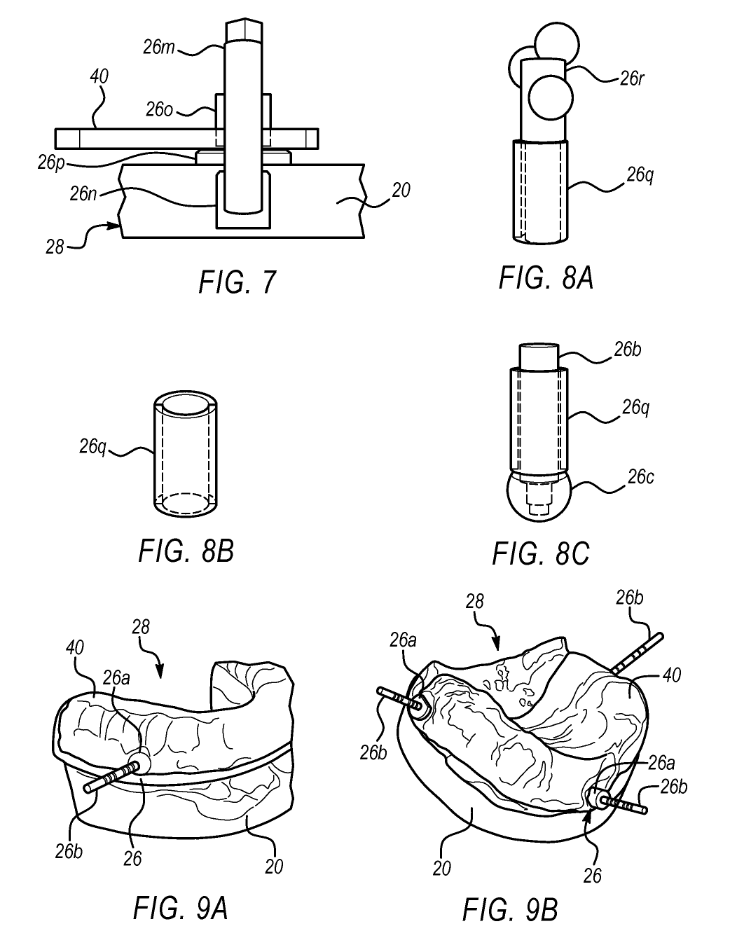

Referring now to FIG. 7, a side view of a linking component including fastener connector component 26m is illustrated with an anchor 26n embedded within a linkable model with linking parts 28. A radio-opaque imaging/scaling tube-shaped marker 26o can be made in a variety of lengths, and associated or fixed with respect to a linkable imaging template with linking parts 40. An optional spacer 26p can be located between an anchor 26n and an imaging/scaling marker 26o, if desired.

Referring now to FIGS. 8A-8C, by way of example and not limitation, an interchangeable cylindrical or tube shaped component 26q can be made of radio-opaque or non-radio-opaque material and used in combination with more complex shaped fastening connector component 26r made from radio-opaque or non-radio-opaque material for CT scanning, CB CT scanning, MRI scanning, or 3D surface scanning devices. The cylindrical component 26q can be supported by an orientation anchor 26c, or other anchor component such as those described above, and fastening connector component 26b combination with respect to a linkable model with linking parts 28. The anchor 26c and fastening connector component 26b can provide placement, angular orientation, and fixturing of the cylindrical component 26q with respect to a linkable imaging template with linking parts 40. After the cylindrical component 26q is removed from the fastening connector component 26b, a more complex shaped fastening connector component 26r can be supported within the interchangeable component 26q for 3D surface scanning devices.

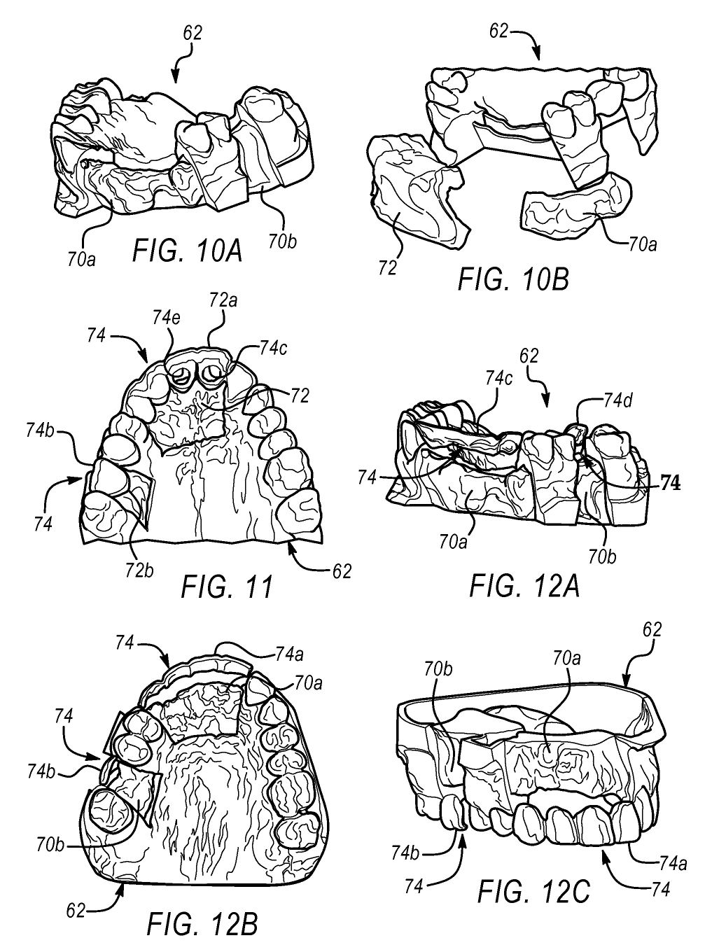

Referring now to FIGS. 9A-9B, a linkable model with linking parts 28 is illustrated. All of the tissue area on the linkable model has been blocked out with a thin layer of block out material. Fastening connector component 26b can be inserted into corresponding anchors 26c. Radio-opaque imaging/scaling markers, by way of example and not limitation, such as markers 26a, 26j, 26n, 26o or 26q described in greater detail above, can be placed on the fastening connector component 26b for an imaging scan, such a 3D surface scanner to create a first imaging scan data set or surface scan data file. Tray material can be applied to the model embedding the radio-opaque linking components 26 to form a linkable imaging template with linking parts 40. The linking components 26 extend sufficiently outside of the imaging template to be exposed. Radio-opaque diagnostics can be placed on the model, and incorporated into the imaging template, if desired. The fastening connector components 26b can be removed from the cured imaging template and underlying model to allow the imaging template to be removed from the model and cleaned. Optionally, the cleaned imaging template can be repositioned on the model, and a 3D surface scan can be performed to create a surface scan data file of the imaging template, if linking components 26 are exposed sufficiently for surface matching to create a second imaging scan data set. The imaging template can then be sent to a doctor's office and positioned in the corresponding patient's mouth for another imaging scan to create a third imaging scan data set. Optionally, the imaging template alone can be subjected to an imaging scan to create a fourth imaging scan data set. The imaging scan of the patient with the imaging template in place can be selected from one or more of the following scans: a CT imaging scan of a physiology of the patient and imaging template, CB CT imaging scan of the physiology of the patient and imaging template, and MRI imaging scan of the physiology of the patient and imaging template. Scanned data can be sent or transferred between the doctor and/or technician as required using any suitable media or device or protocol. CT data files, CB CT data files, and MRI data files can be translated into a file format corresponding with 3D surface scanning data, or the data files can be converted into any compatible file format desired. After being translated into a compatible file format, the first, second, third, and optionally fourth data sets can be scaled, aligned, oriented and linked using the linking components 26 existing in each of the data sets.

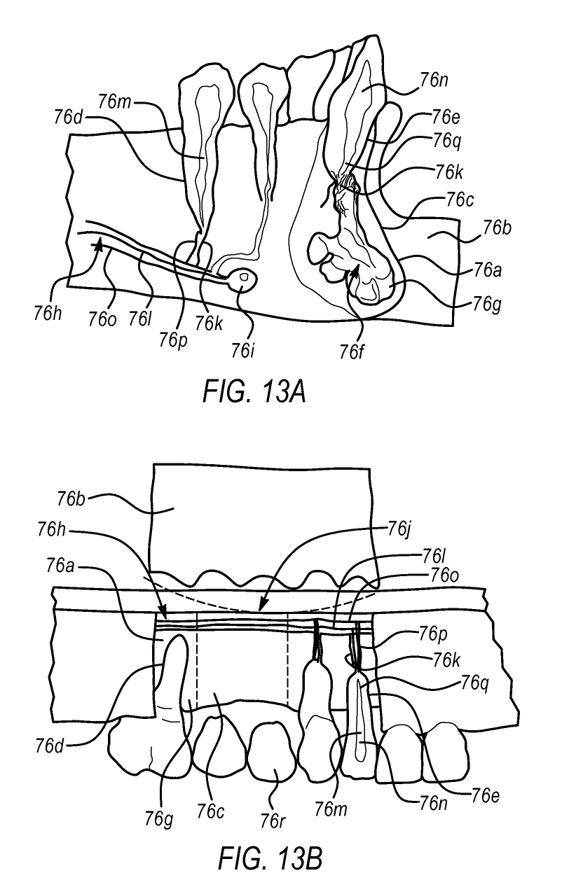

Referring now to FIG. 10A, a physical three dimensional (3D) diagnostic model 62 is illustrated with partially exposed bone structure portion 70a, 70b with or without a removable tissue portion 72, as shown in FIG. 10B. The 3D diagnostic model 62 can be made of solid color material, a transparent material, or a combination of different colors and/or a combination of different types of materials, by way of example and not limitation, such as hard materials, flexible materials, plastic materials, metal materials, ceramic materials, stone materials, or any combination thereof Different combinations of transparent, opaque, and solid colored materials can be used when desired to make various physiology in a diagnostic model of a particular patient visible, i.e. providing a visualization portion 76 of detailed bone/tissue anatomy for the doctor or surgeon of a proposed treatment site including internal three dimensional printed structures, by way of example and not limitation, such as an exposed bone structure 76a, removable gum tissue 76b, removable bone structure 76c, a root of a tooth 76d, a root section contour of a tooth 76e, bone density 76f, internal bone structure 76g, a nerve channel 76h, a major nerve ending 76i, a sinus cavity 76j, a tooth blood vessel 76k, an artery 76l, a tooth root canal 76m, a tooth pulp canal 76n, a major nerve 76o, a tooth nerve 76p, a tooth nerve ending 76q, diagnostic teeth 76r, and any combination thereof as shown schematically in FIG. 13A-13B. The 3D diagnostic model 62 can include an XYZ measurement scale placed in at least one location for verification of accuracy of the model. Information related to the case can be printed on the 3D diagnostic model 62, by way of example and not limitation, a doctor's name, a patient's name, an identification number, a case reference number, or any combination thereof. The 3D diagnostic model 62 can be created by different methods, by way of example and not limitation, such as computer numeric controlled (CNC) milling machines, and various types of 3D printers. When 3D printers are used to create physical three dimensional printed structures of the 3D diagnostic model 62, not only surface defects of the bone, but also porosity inside the bone cavity be visible by slicing the model 62 or coloring the porous area on transparent models. Depending on the quality of the CT/CB CT/MRI scan data bone density can be color coded also. By using a 3D printer, the 3D diagnostic model 62 can be printed along with an opposing model articulated properly with a functioning printed articulator, since 3D printers can print these components together or separately. In any case, the 3D diagnostic model 62 can include various types of fixed or removable diagnostic components as described in greater detail below.

Referring now to FIG. 11, a physical 3D diagnostic model 62 is illustrated with a diagnostic component 74, by way of example and not limitation, bordered tissue/tissue veneer diagnostic 72a, 72b and facial veneer diagnostic 74a, 74b. Diagnostic components 74 can be placed within and/or onto a 3D diagnostic model 62 and can include fixed diagnostic teeth, and/or fixed diagnostic tissue, and/or removable diagnostic teeth and/or removable diagnostic tissue. Diagnostic components 74 can be made by any suitable traditional process, by way of example and not limitation, such as diagnostic wax-ups, plastic or radio-opaque plastic diagnostic teeth duplicated from wax diagnostics. If desired, the plastic can be ultraviolet (UV) or white light cured plastic. Diagnostic components 74 can be made with precious, semi-precious, or non-precious metals. Diagnostic components 74 can be virtually designed separated from or incorporated within the 3D diagnostic model 62. The virtually designed diagnostic components 74 can be manufactured in conjunction with or separately from the 3D diagnostic model 62 by CNC milling machines, or various types of 3D printers. The diagnostic components 74 can be made of waxes, plastics, or various types of metal like traditional diagnostic components. By way of example and not limitation, diagnostic components 74 can include solid teeth, either connected to or separated from each other, veneers, such as facial veneers 74a, 74b illustrated in FIGS. 11, 12B, 12C or lingual veneers 74c, 74d illustrated in FIG. 12A, bordered tissue, tissue veneers, or different combinations of various veneers, either connected to or separated from each other. Diagnostic components 74 can also include lingual tissue or bordered tissue veneer designs, which can also be attached to a facial veneer, or layered onto the tissue material separated from the facial veneer. Hollow diagnostic component 74 designs, i.e. negative of solid shapes, connect to or separated from each other, can be printed within the material that is adaptable onto or with the 3D diagnostic model 62. Diagnostic components 74 can also include implants and all implant related components, by way of example and not limitation, such as different types of implant bars, abutments, and surgical guide designs. Implant diagnostic components 74 can be solid or hollowed out. Implant diagnostic components 74 can also have apertures 74e in the middle of the implant positions so that the pins 26b can be inserted to create a simple surgical guide, or can be created with pins 26b in the middle of the implant positions. Diagnostic components 74 can also include parts for orthodontics, parts for periodontics, parts for oral surgeons, parts for education, or any combination of the diagnostic components 74 discussed above.

Referring again to FIG. 12A, a physical 3D diagnostic model 62 is illustrated with at least partially exposed bone structure portions 70a, 70b and a diagnostic component 74, by way of example and not limitation, a lingual veneer diagnostic 74c, 74d. Diagnostic components 74 can be placed within and/or onto a 3D diagnostic model 62 and can be either fixed or removable. Tissue portions are not provided with this 3D diagnostic model 62, or if provided have been removed.

Referring again to FIGS. 12B-12C, a physical 3D diagnostic model 62 is illustrated with at least partially exposed bone structure portions 70a, 70b and a diagnostic component 74, by way of example and not limitation, a facial veneer diagnostic 74a, 74b. Diagnostic components 74 can be placed within and/or onto a 3D diagnostic model 62 and can be either fixed or removable. Tissue portions are not provided with this 3D diagnostic model 62, or if provided have been removed.

Referring now to FIGS. 4A and 4B, a plurality of diagnostic parts, by way of example and not limitation, such as between 3 mm-6 mm, inclusive, slotted, drilled, diagnostic orientation ball 26f and pin 26d combinations associated with a simplified, schematically drawn, hollow bone section 66 of a diagnostic model. The pin 26d is removable from the orientation ball 26f, and can be any desired configuration, by way of example and not limitation, such as press fit, snap fit, or threaded. The hollow bone section model 66 can be drilled subgingevally, lingually, facially or palatally in one or more locations to form an aperture 68 of a suitable diameter for a diameter of desired diagnostic orientation ball 26f and pin 26d combination. The orientation ball 26f allows angular orientation of an axis of the associated pin 26d prior to fixation with respect to the hollow bone section 66 of the diagnostic model. When properly positioned within the site for dental restoration, the orientation ball 26f and pin 26d combinations allow a simple surgical guide made on the diagnostic model for implant placement.

Linking components 26 can include (1) an anchor or receptor having an aperture to be fixedly connected to a dental master model; (2) a fastening connector component to be removably connected to the anchor or receptor at one end for supporting at least one of an optional spacer and/or an imaging marker; (3) an optional spacer, if required to space an imaging template from the dental master model; and (4) a scaled and shaped imaging marker to reduce and/or eliminate information detail loss due to scatter using radio opaque material suitable for various types of tomography scanning devices such as CT, CB CT, and MRI scanners, and also suitable for 3D surface scanning devices such as laser and optical scanners, thereby allowing replacement of information lost with scan of model or patient's mouth to clean up CT scan data, CB CT scan data, and/or MRI scan data through both image linking and physical linking. Linking components 26 can link imaging templates, dental models, tomography scan data, and surface scan data by creating more accurate visual markers with physically linkable parts where necessary. Imaging markers may have different geometric shapes for scaling and sizing, and usually made of radio-opaque materials for use with tomography scanning devices, such as CT scans, CB CT scans, MRI scans, and 3D surface imaging devices, such as laser scanners, optic scanners, and/or intra-oral scanners. Optionally, the physical linking components can include a non-radio-opaque surface marker component that is interchangeable with a radio-opaque imaging/surface marker, where physical linking and surface scanning data are desired, where radio-opacity will not be needed. A surface marker component contains at least some of the same geometric shape of an imaging/surface marker. When imaging markers are radio-opaque, dual function imaging/physical linking components 26 should be placed on areas where possible image scatters from existing metal crowns, post, etc. in the patient's mouth do not become the disturbance. For this reason, the dual function imaging/physical linking components should be commonly placed below the gum line, preferably at multiple locations, where the locations should be decided on a case by case basis. Radio opaque imaging tubes 26q, as a part of linking components 26, can be placed at possible locations of implants only when the patient does not have any metal crowns in the mouth where image scatter becomes a disturbance. For cases with metal crowns, another type of linking component 26, such as shorter tubes, small spheres, or other variation of shapes can be used in the area where disturbance from image scatter does not occur.

The functions of linking components 26 include the ability, by aligning the markers, to accurately link data from different sources of imaging devices, to clean distorted portions of data from CT/MRI/CB CT or other imaging devices by replacing the distorted portions of data with accurately aligned surface scan data. This function also allows users to replace less accurate CT/MRI/CB CT data with more accurate surface scan data in the area where more accuracy is needed for creation of dental restorations. The function of the linking components includes the ability to scale, size, align, orientate (XYZ co-ordinance), and verify the data from MRI, CT, CB CT and other imaging devices, as well as the data from optical (or laser) 3D surface scanning devices, or intra-oral surface scanning devices.

A virtually designed imaging template includes a data file containing dental model data, design of an imaging template created on the dental model data, and at least one imaging/surface marker design which location is also marked on the dental model data to create a linkable data file. A printed (or milled) virtually designed imaging template contains at least one imaging/surface marker or imaging/surface marker receptor site for the placement of an image/surface marker. Virtual generated 3D data can include CAD-CAM software and the artistic renderings from this software.

The dental device and method is a diagnostic device that accurately links a physical model to CT scan, CB CT scan, MRI scan information and/or optical scan information and/or laser scan information critical for proper diagnosis. Compared to the techniques currently used, the manufacturing process of this appliance is much simpler and faster, even though the appliance is more intricate.

The dental device and method has applications for dental and/or medical uses. By way of example and not limitation, the applications can include bridging or linking the following data: (1) 3D surface scanning data to CT scan, CB CT scan and/or MRI scan data; (2) 3D surface scanning data to CAD virtually generated 3D data; (3) CT scan, CB CT scan, and/or MRI scan data to CAD virtually generated 3D data; (4) CAD virtually generated 3D data to CAD virtually generated 3D data; and (7) in any and all combination of the aforementioned. The bridging or linking of data is for the purpose of diagnosing, treatment planning, educating, communicating, and accurately transferring data, either of a physical nature or an artistic nature, in digital or physical model form, and to any combinations of these types of information or data to the doctors, patients and technicians. The digital and/or physical model form data can also be transferred to the manufacturing facilities, allowing the manufacture of additional diagnostic tools and/or components, and to assist in the manufacturing of finished or partially finished prosthetics and/or prosthesis.

The dental device and method according to one embodiment of the invention, being able to accurately link and transfer these different groups of information—physical, CT scan, CB CT scan, MRI scan, and virtual computer aided design-computer aided manufacturing (CAD-CAM), makes possible faster manufacturing processes, that can help doctors and technicians communicate with accuracy and greater artistic abilities and more intricately produced prosthesis and prosthetics in a much faster time period than presently used techniques. This will also provide the patient and doctors with the most complete and accurate diversified package of information for their decision making process.

### Constructing A Linkable Model 28

Method 1. Starting from a dental impression, inspect and sanitize the dental impression received from the dentist. Drill holes through the impression material and the tray in one or more locations subgingivally, lingually, facially, or palatally. The diameter of the holes corresponds with the diameter of the fastener connector component. Insert the fastener connector component into the holes through the tray and the impression material. Place the linking anchors inside of the tray at the end of each fastener connector component. Make sure the anchor is touching the impression material. Fastener connector component and anchors are placed in the impression. Box in the dental impression with wax strips or other boxing materials, and pour the model material into the boxed impression. Remove the fastener connector component from the impression and the model when the linkable model 28 is cured and hardened. Separate the linkable model 28 from the impression. Clean and prepare the linkable model 28 in the traditional way. An anchor is embedded inside of the model. A linkable model 28 is provided with anchors, and fastening connector components and linking imaging/scaling marker components can be placed on the anchors.

Method 2. Starting from a dental master model 20, drill holes into the dental master model 20 subgingevally, lingually, facially or palatally in one or more locations. The diameter of the holes corresponds with the diameter of the anchors. Insert and secure the anchors into the holes of the dental master model 20. An anchor is fixed inside of the dental master model 20. A linkable model 28 is created with anchors, and fastening connector components and linking imaging/scaling marker components can be place on the anchors.

### Constructing A Linkable Imaging Templates 40 By Hand

Method 3: Starting from a linkable model 28 (made by either method 1 or method 2 above) construct the imaging template 40 by hand. Insert the fastening connector components into the anchors and place the additional radio-opaque linking imaging/scaling marker components on the fastening connector components. Different styles of linking components can be used, by way of example and not limitation, such as screw, snap, and friction fit, etc. Scan the linkable model 28 with the linking components including linking imaging/scaling marker components using the 3D surface scanner (data #1). Block out all the tissue area on the linkable model 28 with thin layer of block out material because of the tissue's flexibility in the patient's mouth. Make sure that there is no block out material on the linking anchors. Apply the tray material, by way of example and not limitation, such as ultraviolet (UV) light cured plastic, or light cured plastic, or thermal plastic to the model, and form the imaging template embedding the radio-opaque imaging/scaling marker in the material. Make sure that the radio-opaque imaging/scaling markers are somewhat exposed outside of tray. Optionally, radio-opaque diagnostics may be placed on the model, and incorporated into the template, if desired. Process the tray material according to the type of material used. When the tray material is fully cured and hardened, remove the fastening connector component and then the imaging template from the model. Clean the imaging template. Try the linkable imaging template back on the master model. 3D surface scanning can be also done at this point if linking components are exposed enough for surface matching (data #2). The imaging template is sent to the doctor's office, and tried in the patient's mouth. CT/CB CT/MRI (or other imaging devices) scanning is done with the imaging template in the patient's mouth (data #3). Optionally, the imaging template alone can be scanned by CT/CB CT/MRI (or other imaging devices) for the second time (data #4) if desired (it is not necessary for linking). Scanned data is sent to the doctor and/or the technician. Translate CT/MRI data files into the file format that corresponds with the 3D surface scanning data, and data #1 through #4 are now ready to be linked into a master data file.

### Constructing A Linkable Imaging Template by Virtual Designing From a Linkable Model

Method 4: Starting from a physical linkable model (made by either method 1 or method 2 above), and virtually constructing the linkable imaging template. Scan the linkable model to create a first data file (data #1). Scan the patients bite registration to create a second data file (data #2). Virtually block out all the tissue area on the virtual dental model because of the tissue's flexibility in the patient's mouth. Virtually design an imaging template that adapts to the solid structures (such as teeth or exposed bones) on the virtual dental model, incorporating the information from the bite registration scan data. Optionally, virtually design diagnostics into the imaging template, if desired at this point. Virtually design into the imaging template linking components so that anchors align with corresponding fastening connector components and corresponding imaging/scaling markers on the virtual dental model. The imaging/scaling marker components can be printed as radio-opaque solids along with the linkable imaging template or as hollowed out areas that will be filled with radio-opaque material after printing. The virtually designed imaging template with linking components defines a third data file (data #3). Send the design data (data #3) to a 3D printer, and manufacture the linkable imaging template. Clean the imaging template, and check it on the actual physical linkable model. The linkable imaging template is sent to the doctor's office, and tried in the patient's mouth. CT/CB CT/MRI (or other imaging devices) scanning is done with the linkable imaging template in the patient's mouth to create a fourth data file (data #4). Optionally, the linkable imaging template can be scanned by itself with CT/CB CT/MRI (or other imaging devices) for the second time to create a fifth data file (data #5), if desired since this data is not necessary for linking. Scanned data is sent to the doctor and/or the technician. After translating the CT/CB CT/MRI data files (data #3, data #4, and/or optional data #5) into a compatible file format that corresponds with the 3D surface scanning data files (data #1 and/or data #2), and data files #1 through #4 (and optionally #5) are now ready to be linked into a master data file. It should be noted that a physical linking component on the linkable model can be useful when the surface of the imaging template is altered later.

### Constructing A Linkable Imaging Template 40 (Without Linking Device on the Master Model) by Virtual Designing

Method 5: Start from an intra-oral scanning 14 data file, or dental impression data file after being inverted 22, or virtual dental model data file 32 to virtually construct the linkable imaging template 40. Any of the above data files or sets of data from intra-oral scanning 14, dental impression 22, or virtual dental model 32 can define a first data file (data #1). Scan the patients bite registration to define a second data file (data #2). Virtually block out all the tissue area on the virtual dental model 32 because of the tissue's flexibility in the patient's mouth. Virtually design an imaging template 36 that adapts to the solid structures (such as teeth or exposed bones) on the virtual dental model 32, incorporating the information from the bite registration scan data. Optionally, virtually design diagnostics into the imaging template, if desired at this point. Virtually design into the imaging template linking components so that align anchors align with fastening connector components and imaging/scaling markers on the virtual dental model 32. The imaging/scaling marker components can be printed as radio-opaque solids along with the linkable imaging template 40 or as hollowed out areas that will be filled with radio-opaque material after printing. The virtually designed imaging template with linking parts 40 defines a third data file (data #3). Send the design data (data#3) to a 3D printer, and manufacture the linkable imaging template 40. Clean the imaging template, and check it on an actual dental master model 20. The linkable imaging template 40 is sent to the doctor's office, and tried in the patient's mouth. CT/CB CT/MRI (or other imaging devices) scanning is done with the linkable imaging template 40 in the patient's mouth to create a fourth data file (data #4). Optionally, the linkable imaging template 40 can be scanned by itself with CT/CB CT/MRI (or other imaging devices) for the second time to create a fifth data file (data #5), if desired since this data is not necessary for linking. Scanned data is sent to the doctor and/or the technician. After translating the CT/CB CT/MRI data files (data #3, data #4, and/or optionally data #5) into a compatible file format that corresponds with the 3D surface scanning data files (data #1 and/or data #2), and data files #1 through #4 (and optionally #5) are now ready to be linked into a master data file.

Suitable equipment for any of the products, methods and processes described above is commercially available. By way of example and not limitation, suitable 3D prototyping printers are commercially available, such as sold under either the EDEN series or CONNEX series (for multi-material 3D prototype printing) by Objet Geometrics, Inc. having an office in Billerica, Mass. and a headquarters located in Rehovot, Israel, or such as sold under FORTUS 3D Production Systems by Stratasys, Inc. having headquarters located in Eden Prairie, Minn. By way of example and not limitation, suitable colored and translucent materials are commercially available under tradenames such as FULLCURE material or VERO material sold by Objet Geometrics, Inc. having an office located in Bellericda, MA and a headquarters located in Rehovot, Israel, or under the tradenames ABSi material, or ABS-M30i material, or PC-ISO material sold by Stratasys, Inc having headquarters located in Eden Prairie, Minn. By way of example and not limitation, suitable radio opaque materials are commercially available under tradenames such as VIVO TAC materials or ORTH TAC materials sold by Ivoclar Vivadent AG having an office in Amherst, N.Y. and a headquarters in Schaan, Liechtenstein. By way of example and not limitation, suitable computer numeric controlled (CNC) equipment is commercially available, such as sold under either the VR series or VF series CNC equipment by Haas Automation, Inc. located in Oxnard, Calif., or such as sold under either the MCD series or the MAG series, or the V series by Makino, Inc. located in Tokyo, Japan. By way of example and not limitation, suitable software is commercially available, such as CT/MRI 3D view & STL translation software sold under the name MIMICS by Materialise MGX located in Leuen, Belgium, or sold under the name INVIVO DENTAL by Anatomage, Inc. located in San Jose, Calif.; or sold under the name SCANIP by Delcam, PLC located in Birmingham, UK. By way of example and not limitation, suitable software is commercially available, such as modeling/designing software sold under the name GEOMAGIC STUDIO by Geomagic, Inc. located in Research Triangle Park, N.C., or sold under the name COPY CAD, POWER SHAPE, ART CAM by Delcam, PLC located in Birmingham, UK. Each of these commercially available products can be used in any combination, subject to the manufacturer's recommendations for combining materials and prototyping printer models, to manufacture the products or practice the methods and processes described in greater detail above.

However, when determining the location of an implant site for an edentulous patient, several challenges arise. The challenges become even more substantial when precise implant placement is a paramount consideration to the success of the treatment (e.g., due to the type of restoration, the patient's bone structure, and/or the condition of the patient's bone density). One conventional approach for determining implant site location includes the creation of an imaging denture with radio-opaque teeth, performing a tomography scan of the patient wearing the denture, and then creating a surgical drill guide. Unfortunately, however, soft malleable gum tissue in a patient's mouth can move in all three dimensions (i.e., along perpendicularly extending X, Y, Z axial directions). As a result, the data collected using the denture only represents the bone-tissue-denture relationship at one particular moment. A distinct positioning marker would help reduce distortion caused by the malleable gum tissue.

Although described with respect to implant surgeries, the following dental device, method, and system can be used in conjunction with other oral procedures and diagnosis including, but not limited to, bone grafting and maxillofacial reconstruction.

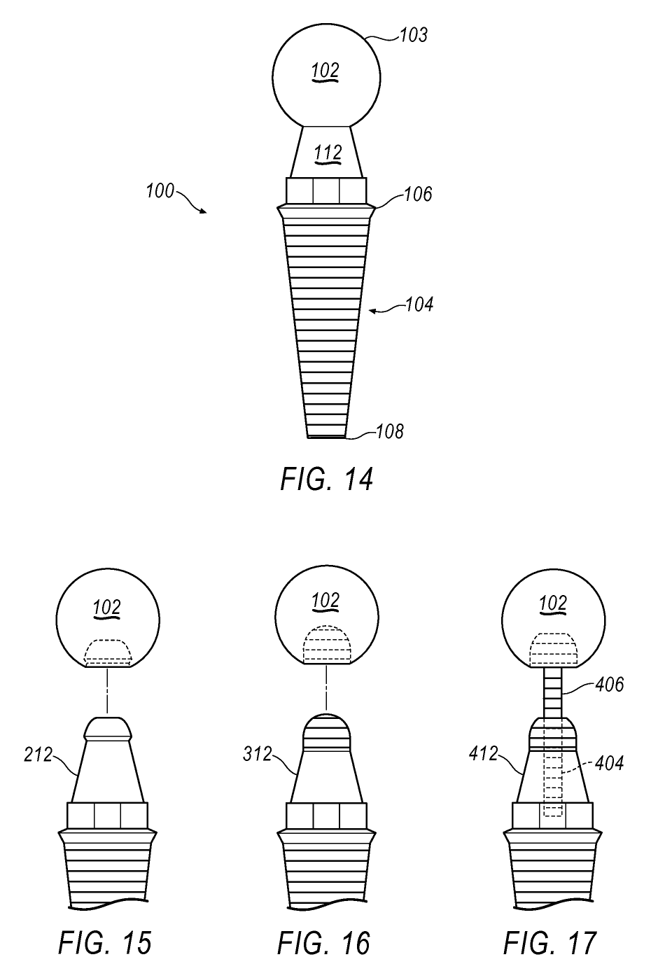

FIG. 14 illustrates an example of a dental device 100 having a marker 102 and a linking component 104 that may be inserted into the mouth of a patient and used to verify and orient data from at least one of a tomography imaging scan and a surface imaging scan. While an exemplary device 100 is suitable for patents having an edentulous condition, it may also be used in patient's having partially edentulous conditions.

In FIG. 14, marker 102 is illustrated as having a generally spherical free end 103. However, marker 102 may be cylindrical, frustoconical, cube shaped, or encompass any other geometric design that accommodates the needs of the procedure or the oral structures of the patient. Marker 102 may also be made at least partially of a radio opaque material. The radio-opaque material may be a thermoplastic, a ceramic, or any other suitable material, or any suitable combination of materials capable of inhibiting electromagnetic radiation. This allows marker 102 to be viewable during CT scans, CB CT scans, CT VT scans, MRI scans, and other types of three-dimensional surface scanning. The marker may also be viewable in surface scans.

The marker 102 may be a radiodensity comparative reference marker. Radiodensity comparative reference markers may be formed using various chemical compositions. This allows the reference marker 102 to have a different radiodensity based on the chemical composition that is selected. Although an exemplary reference marker 102 is shown, the reference marker may take on any suitable configuration, including a sticker like reference marker that adheres to the dental device 100.

One benefit of using radiodensity comparative reference markers is that the accuracy of the tomography scan data may be evaluated using such markers. For example, CT scans or MRIs create a series of two dimensional pictures that may vary in accuracy depending on whether or not the machine is properly calibrated. When reconstructing tomography scan data into three dimensional images, often done with volumization software, a threshold value of grey scale radiodensity may be quantified using a Hounsfield Unit (HU). However, the software threshold value may not be consistent with the threshold valued indicated in the scan data file, since each read out of the scan data may be affected by one or more factors such as the calibration of the scanner, the method of image acquisition, the computer software being used, or image scatter. However, the use of a radiodensity comparative reference marker may provide a “built-in” standard. That is, the operator may use a radiodensity comparative reference marker with a known density as a reference to tune the threshold setting of the software for volumization of the data file. This standard may give users a tool to evaluate the tomography data file and to create more accurate bone models.

Another benefit of using radiodensity comparative reference markers is that the reference marker may be used to mimic various degrees of bone density during a tomography scan. Therefore, a radiodensity comparative reference marker with a known density may be used as a reference to tune the threshold settings of the volumization software. This may provide a model with a more accurate representation of a patient's bone density. As mentioned above, the condition of patent's bone density can affect the success of a dental treatment. This is especially true with respect to the placement of a dental implant.

Another exemplary marker 102 that may be used is a negative marker. By designing marker 102 with a cavity or other similar structure of a certain size and geometric shape a negative linkable marker can be created. This cavity, which is substantially devoid of material, will appear as a geometrically shaped black space in the tomography scan data of a patient when the threshold density is set at the same radiodesity density level as the marker 102. This density level may be the density level of skin. The negative marker may also increase the accuracy of the tomography scan data because the empty space will offer the clearest image of the marker outline without distortion.

Marker 102 may be integral with linking component 104 or it may be releasably engagable, as discussed below. FIG. 14 also illustrates linking component 104 having a proximal end 106 and a distal end 108. Linking component 104 may be formed of non-integrating types of metal, ceramic, hard plastic or any other suitable materials that do not cause distortion in the data from the tomography scan. Distortion, commonly referred to as scatter, in tomography scans occurs when certain radio-opaque materials, such as metal crowns, filings, posts, and implants are present in the mouth of a patient. The presence of such materials causes the scan data to scatter making the image unreliable, inaccurate, and unusable as a proper diagnostic tool.

The distal end 108 of linking component 104 may include an insertion mechanism configured to penetrate an oral structure, such as gum tissue 107 or bone structure 109. In FIG. 14, the insertion mechanism is illustrated as a screw thread 112, however, other suitable mechanisms including a tap-in mechanism could be used to insert linking component 104 into an oral structure. Screw thread 112 may be formed on a portion of distal end 108, the screw thread 112 may extend partially between distal end 108 and proximal end 106, or it may extend from distal end 108 to proximal end 106 of linking component 104. The pitch of the screw thread 112 may be varied to accommodate the needs of the specific patient based on the type of restoration, the patient's bone structure 109 and/or bone density.

In one exemplary approach, the diameter of linking component 104 may increase at a constant rate from distal end 108 to proximal end 106. Accordingly, the diameter of the linking device may range from approximately 1 mm to 2.5 mm between distal end 108 and the proximal end 106. In another exemplary approach, a length of linking component 104 may range from approximately 4 mm to 21 mm depending on the thickness of a patient's gum tissue 107 and the depth of insertion into the patient's bone structure 109 necessary to secure the device 100. Once inserted, linking component 104 may remain in the patient's month for approximately eight months.

Marker 102 may be positioned adjacent to proximal end 106 of linking component 104. In one exemplary approach, the proximal end 106 may include a fastening head. The fastening head may be engaged with linking component 104 in any suitable manner including, but not limited to, screwing, bolting, snapping, or the fastening head may be integral with the linking component. In FIG. 14, the fastening head is illustrated as a screw head 112.

Screw head 112 may have a frustoconical shape including an angle of taper that may range between approximately 15° and 20°. This shape may provide better imaging of the device, discussed in detail below, when multiple dental devices are inserted into the mouth of a patient. However, screw head 112 may be designed as any geometric shape suitable to engage marker 102 and capable of being detected in a tomography image scan and/or a surface image scan.

Marker 102 may be integral with screw head 112 or marker 102 may be releasably engagable with screw head 112. As shown with respect to FIGS. 15 and 16, a releasably engagable marker may be engaged with screw head 112 in any suitable manner including, but not limited to, snapping marker 102 onto snap-on head 212 and screwing marker 102 onto screw head 312. FIG. 17 also illustrates a releasably engagable marker 102 wherein screw head 412 includes a receptor 404 configured to receive a screw portion 406 of marker 102 or any other suitable device.

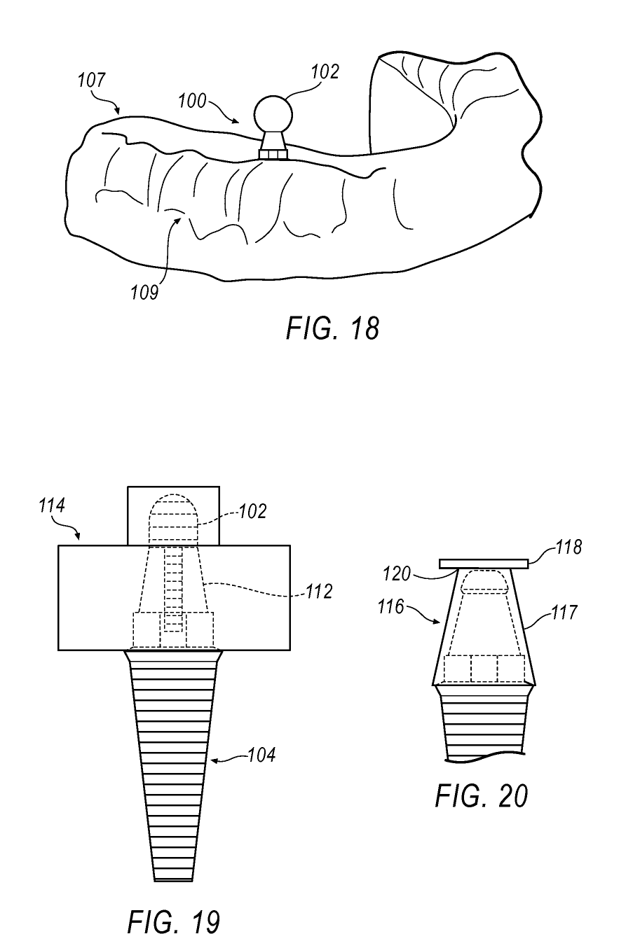

At least one advantage of utilizing a releasably engagable marker is that different sized and shaped markers can be utilized without having to remove the linking component 104 from the mouth of the patient. Marker 102 may be engaged with its respective screw head 112, 212, 312, and 412 before the distal end of linking component 104 is inserted into an oral structure or after linking component 104 has been inserted. As seen in FIG. 18, using marker 102 as an example, once linking component 104 is inserted, the marker is positioned above the gum tissue 107.

Continuing with FIG. 18, after insertion of at least one dental device 100 into a patient's mouth, a tomography scan and/or a surface scan of the patient's mouth or a dental model representing the mouth may be performed. As previously discussed, the tomography scan may be performed using a CT, a CB CT, a CB VT, an MRI, or any other suitable imaging device. The data from the tomography scan may be used to create a tomography scan data set. The data typically represents the orientation and positioning of dental device 100 as well as the patient's underlying bone structure 109, basic anatomy, and any anomalies. Also, as previously discussed, the surface scan may be performed using an intra-oral surface scan of the patient's mouth or the scan data may be collected by performing an optical image scan of a dental model, a laser image scan of the dental model, or a surface scan of the dental model. The data from the surface scan includes the orientation and positioning of dental device 100 as well as any other oral structures present on the outer surface of the gum tissue 107 and inside the mouth.

As discussed above, the tomography scan data set and the surface scan data set may be linked to create a master data file. The master data file may be used for evaluation or to create a digital or physical diagnostic model that is an accurate representation of a patient's oral structures, including bone structure 109 and gum tissue 107. That is, the presence of at least one dental device 100 in the tomography scan data set and the surface scan data set provides a temporary positioning reference point that enables accurate linking of the data sets by aligning the images of the dental device 100 in both data files. By linking the data sets, distorted portions of the tomography scan data set may be replaced with more accurate data from the surface scan data set.

The linked data from the tomography scan and the surface scan may also be used to verify the scaling and sizing of the data contained within the tomography scan data set and the surface scan data set. Verifying the scaling and sizing of the data is important when precise implant placement is paramount due to the type of implantation necessary or due to the condition of the patient's bone structure 109. One way to verify the scaling and sizing of the scanning images is to compare the known size and shape measurements of the implanted dental device 100 to the size and shape measurements of dental device 100 as it appears in the scanning images.

As illustrated in FIG. 19 the tomography scan data set and the surface scan data set may also be used to design a dental appliance 114 that may be used separately or in combination with dental device 100. Dental appliance 114 may be, but is not limited to, a jig, a transfer jig including partially pre-fabricated surgical transfer jigs, different types of surgical guides including surgical implant drill guides, different types of surgical placement guides including surgical implant placement guides, dentures, and bite registrations.

As also shown in FIG. 19, dental device 100 may be configured to support dental appliance 114. Dental appliance 114 may be disposed on screw head 112 at the proximal end 106 of linking component 104. Dental appliance 114 may be engagable with screw head 112 in any manner suitable, including but not limited to, snapping appliance 114 onto screw head 112 and screwing appliance 114 into screw head 112. The dental appliance 114 may be designed in a patient's mouth or on a physical diagnostic model or a digital diagnostic model using the master data file. Digitally designed appliances may be manufactured via 3D printing or CNC milling. Depending on the function of the appliance 114 and the procedure being used, the appliance may be formed from a single piece or it may be assembled using multiple pieces.

Returning back to FIG. 18, with respect to surgical guides, as discussed, the tomography scan data set provides images of the structures inside the patient's mouth, including the patient's bone structure 109, and the surface scan data set provides information related to the unique contours of the patient's gum tissue 107 and other structures on the surface of the gum tissue 107 or within the mouth. When the data is linked using dental device 100, the dentist is provided with an accurate representation of the patient's oral structures both above and below the gum tissue 107. This information may then be used to form a surgical guide on a digital diagnostic model or a physical diagnostic model created from the scan data files. The surgical guide appliance will accurately guide a dentist's drilling procedure or insertion of a dental implant, preventing the dentist from missing the patient's bone structure 109, inserting the implant into an area of compromised bone structure, and protecting against angulations of the implant.

Dental device 100 may also be used to create a transfer jig to transfer the orientation and positioning of dental device 100, including the height of the device and the angulations of the device, to a physical diagnostic model of the patient's mouth. Generally, after an implant has been inserted, a dentist waits several months for the implant to integrate with the bone before fitting a transfer jig. Therefore, the dentist must reopen the surgical site and pull back the gum tissue 107 in order to align the transfer jig with the previously inserted implant. This procedure results in the need for additional healing time for the patient. Undertaking the procedure may separately lead to the loss of approximately 1 mm of tissue 107 each time it is performed, which is also undesirable. Positioning marker 102, at least partially above gum tissue 107 allows for easier recordation of the location and positioning of an implant using a transfer jig and alleviates the need to reopen the surgical site. This recordation is done using a dental coping.

FIG. 20 illustrates one example of a pickup coping 116 having a base 17 and an optional protuberance 118. Coping 116 may be disposed on top of marker 102 or marker 102 may be removed before coping 106 is disposed on proximal end 106 of linking component 104. Coping 116 may be disposed on marker 102 or proximal 106 in any suitable manner, including a screw or a snap mechanism.

As shown in the illustrative approach of FIG. 20, coping 116 is disposed on top of and generally encloses marker 102 using a snap mechanism. In this example, coping 116 has a frustoconical shape. However, coping 116 may be designed in any geometric configuration suitable for transferring the orientation and positioning of the dental device 100 to a physical dental model. FIG. 20 also illustrates an optional protuberance 118 disposed on a proximal end 120 of coping 116. Protuberance 118 is configured to keep coping 116 embedded in a dental impression, discussed below.

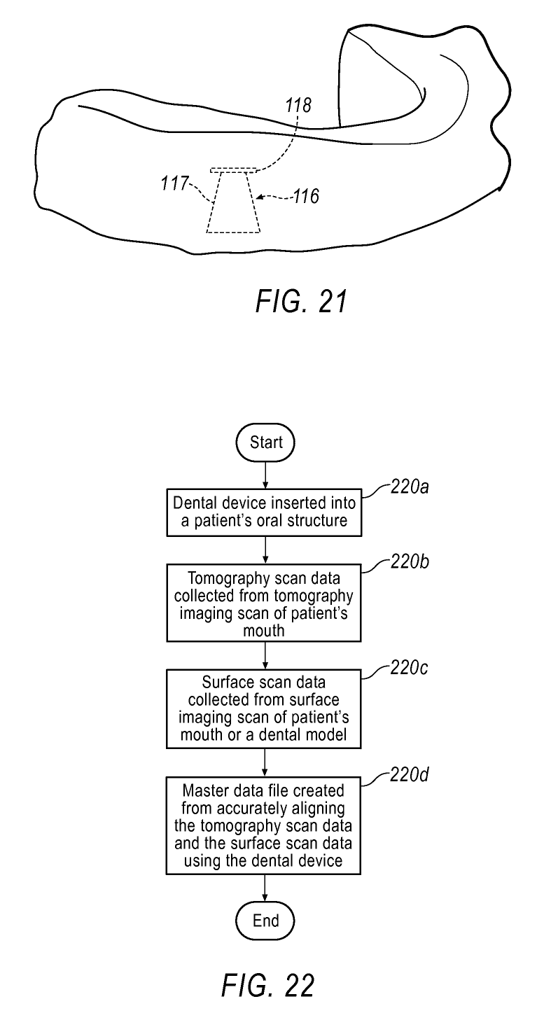

Referring to FIG. 21, once coping 116 is positioned, an impression tray containing any suitable impression material can be used to create a mold of the mouth. When the patient bites down on the impression tray, the impression material will form around the patient's oral structures, including the patient's teeth, gum tissue 107, and coping 116 including protuberance 118. As a result of the design of protuberance 118, when the impression material cures, coping 116 will be embedded in the impression material. Accordingly, when the impression is removed from the patient's mouth, the snap mechanism will release and coping 116 will remain in the impression, illustrated in dashed lines. By capturing coping 116, the dentist can use the impression to more accurately transfer the orientation and positioning of dental device 100 back to the physical dental model. This information can then be used when the dentist is determining final restoration procedures. A partially pre-fabricated jig frame could also be used for this purpose, or a surgical guide could be adapted.

In another exemplary approach, coping 116 may not include protuberance 118. When the patient bites down on the impression tray, the impression material will form around the patient's oral structures, including the patient's teeth, gum tissue 107, and coping 116. However, when the impression material cures, coping 116 will not remain imbedded in the impression material when it is removed from mouth of the patient. Instead, coping 116 will leave an impression in the impression material and an identical coping can later be positioned in the formed impression. Also, the coping 116 in the mouth of the patient may be removed and transferred to the formed impression. Similarly, the impression may be used to more accurately transfer the orientation and positioning of dental device 100 back to the physical dental model.

As another example, bite registrations created or adjusted in the mouth of a patient may be designed to capture the location of marker 102. Marker 102 may then be used as a positioning reference point and the data related to the location and position of marker 102 may be transferred to a diagnostic model.

FIG. 22 illustrates an exemplary approach for using dental device 100 to select a surgical site or perform other dental procedures related to dental implants. As shown in block 220a and discussed above with respect to FIG. 18, at least one dental device 100 may be inserted into the bone structure 109 of a patient. Prior to insertion the dentist may examine the insertion site to avoid damaging vital structures, such as major nerves or the sinuses. The dentist may also want to avoid areas of compromised gum tissue 107 or bone structure 109, and other structures or conditions that may interfere with the surgical site or the success of the procedure. The dentist may also use one drillbit or a series of drillbits of differing sizes to form a pilot hole in the area of the surgical site depending on the type of linking device and screw thread being used. For example, when inserting a large implant, a dentist may drill a pilot hole to prevent fracturing of the bone when the implant is inserted. The dentist may also drill a pilot hole prior to insertion of the dental device when necessitated by the condition of the patient's bone structure in the surgical site area.

If marker 102 is not integral with the linking component, marker 102 may be engaged with linking component 104 before linking component 104 is inserted into the patient's bone structure 109 or after insertion. Marker 102 may be releasably engagable with linking component 104 using any suitable means including, a snap, a screw, or a tap-in attachment mechanism. Once the entire dental device is inserted, the marker is positioned above the gum tissue 107 such that it is viewable, see FIG. 18.

As shown in block 220b and discussed in detail above, after insertion of dental device 100, a tomography scan of the patient's mouth or a dental model representing the patient's mouth, including the dental device, may be performed in order to create a tomography scan data set. The tomography scan may be performed using a CT, a CB CT, CB VT, an MRI, or any other suitable imaging devices. Multiple tomography devices may also be used to create different types of tomography images if desired.

As shown in block 220c and discussed in detail above, a surface scan of the patient's mouth including dental device 100 may also be performed in order to create a surface scan data set. The surface scan data may be collected by performing an intra-oral surface scan of a patient's mouth, an optical image scan of the dental model, a laser image scan of the dental model or a surface scan of the dental model. The surface scan may also be performed on an impression of the patient's mouth. The impression may be taken with the dental device already inserted into the patient's mouth or the impression may be taken without the dental device.

If an impression is taken with dental device 100, the location of the dental device will be preserved in the impression. A dental device 100 of similar size and shape or an analog may be placed in the dental impression in a position that corresponds to the device inserted in the patient's mouth. The impression can then be boxed in with wax strips or other suitable boxing material so that the model material may be poured into the boxed impression, forming a physical diagnostic model. The physical diagnostic model which includes at least one embedded dental device 100, may then be surface scanned to obtain the surface scan data set.

If an impression is taken without dental device 100, a dentist may need to drill holes through the impression in one or more locations subgingevally, lingually, facially, or palatally to accommodate the size and shape of the dental device 100 being inserted. Once the dental device 100 is inserted, the dental impression can be boxed in and the model material may be poured, forming a diagnostic model. The diagnostic model which includes at least one embedded dental device 100, may then be surface scanned to obtain a surface scan data set.

A bite registration, created using the traditional method of a bite plate and a bite block, may also be used to capture the orientation and position of dental device 100. The bite registration may then be scanned on the diagnostic model with a surface scanning device to create a surface scan data set. If desired, additional reference locations may be added to the diagnostic model before the surface scan is performed.

After the tomography scan and surface scan have been performed, the tomography scan data set and the surface scan data set may be aligned to create a combined master data file, as shown in block 220d. To create the combined master data file the tomography scan data may first be analyzed using tomography data volumalizing and converting software. As discussed above, volumalizing software is used to reconstruct two dimensional pictures into three dimensional images. When analyzing the tomography scan data, the data set may represent several oral structures of the mouth. However, in some situations it may be beneficial to segment different portions of the scan to create digital models that represent individual oral structures. For example, the tomography scan data set may be segmented into portions representing the jaw bone, teeth, roots, nerves, etc. If the dental device previously inserted into the mouth of the patient has at least one radiodensity comparative reference marker, as discussed above, the marker may be used to verify the accuracy of the original scan data and/or as a reference to create models of individual oral structures. Once the tomography scan data has been volumalized and its accuracy verified, the data may be converted to CAD (computer aided drafting) compatible data and exported to a modeling system or any other suitable system for appropriate analysis and manipulation. Such system may include hardware, software or a combination of software and hardware.

After translating the tomography scan data set into a file format that corresponds with the surface scan data set, the tomography scan data and the surface scan data may be linked to create the combined master data file. That is, the presence of at least one dental device including at least one marker in the tomography scan data set and a corresponding dental device and marker in the surface scan data set provides a temporary positioning reference location in each data set. These corresponding temporary positioning reference locations enable accurate linking of the data sets because the reference locations present in both scan data sets can be aligned. Thus, the master data file will contain an accurate representation of an entire mouth—the tomography scan data provides imaging of the structures underneath the gum tissue including bone density information and the surface scan data provides imaging of the surface structures of a mouth including oral structures. The master data file may be used for evaluation of potential locations for dental procedures or to create a virtual or physical diagnostic model.

The linked data from the tomography scan and the surface scan may also be used to verify the scaling and sizing of the data contained within the tomography scan data set and the surface scan data set. Verifying the scaling and sizing of the data is important when precise implant placement is paramount due to the type of implant needed. One way to verify the scaling and sizing of the scanning images is to compare the known size and shape measurements of the dental device to the size and shape measurements of the dental device as it appears in the scanning images.

However, a digital design of the dental device, including the marker may also be used to align the tomography scan data and surface scan data. A digital design of the linking device may be provided when the dental device is received or a digital design of the device may be created by surface scanning the dental device. The digital design may then be used to identify the complete structure of the marker in both the tomography scan data set and the surface scan data set in order to accurately align the two data sets. Using the digital design may increase the accuracy of alignment by identifying areas of the marker that may be obstructed in either the tomography scan and/or the surface scan. For example, the outline of a radio-opaque marker may be viewable in the tomography scan data. However, the outline of the entire dental device may be only partially detectable depending on the type of material used. As another example, the surface scan data set may provide an outline of the outer surface of the dental device, but it will not represent the internal structure of a marker nor will it represent the bottom area of the marker that may abut the surface of an oral structure. Given scatter and other types of inaccuracies in the data, simply aligning the outline in the tomography scan data set to the outline in the surface scan data set may not accurately represent the location of oral structures within the mouth. However, aligning the tomography scan data set and the surface scan data set to the digital design may provide a more accurate representation.

In one exemplary approach, the digital design may be aligned with or superimposed over the surface scan data set to indicate the location of any hidden structures not represented in the surface scan data set. For example, superimposing the digital design over the outline of the dental device in the surface scan data may provide a representation of where the marker and/or dental device abut an oral structure. Such areas, if located underneath the device and/or marker, would not be viewable in a surface scan of the mouth. The digital design could then be used to align the surface scan data set to the tomography scan data set using an outline of the device or a portion of the device detectable in the tomography scan data. For alignment, the tomography scan data set and the surface scan data set do not have to have a common plane. Instead, each image can be oriented according to the digital design of the device. Although one exemplary approach for aligning the scan data sets is provided other approaches for aligning the data sets using the digital design may be used. For example, the digital design may first be aligned with the tomography scan data set or the digital design may be used to simultaneously align the data sets. Additionally, the digital design may be used to align more than just two data sets.

The digital design of the dental device may also be used to verify the scaling and sizing of the data contained within the tomography scan data set and the surface scan data set. Verifying the scaling and sizing of the data is important when precise implant placement is paramount due to the type of implant needed.

Use of the digital design also allows for numerous additional design options for the dental device and the maker. For example, a dental device may be designed with a marker entirely or partially enclosed in an external structure. Although an entirely or partially enclosed marker may not be fully detectable in a tomography scan data set and/or a surfaces scan data set, the marker would be visible when the data sets were aligned using the digital design.

After the data sets have been aligned to create a combined master data file, the master data file can then be used for evaluation or to create a digital or physical diagnostic model that contains accurate bone structure 109 and tissue 107 representations. Diagnostic designs including teeth, veneers, tissue and implant components may also be added to the master data file. The master data file may also be used to design various dental appliances including surgical guides.

Further, in some cases, stronger and/or more rigid bone screw linking parts may be used in the diagnostic model to replace the existing linking parts. The replacement linking parts should have the exact size and shape of the head portion of the original parts to allow for proper alignment. As previously discussed, the diagnostic model may then be used to design a dental appliance. The dental appliance may be, but is not limited to, a jig, a transfer jig including partially pre-fabricated surgical transfer jigs, different types of surgical guides including surgical implant drill guides, different types of surgical placement guides including surgical implant placement guides, dentures, and bite registrations.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A dental device comprising:
a linking component having a proximal end and a distal end, the distal end configured to penetrate at least one of an oral structure and a model of an oral structure; and
a marker configured to be a positioning reference location, wherein the marker is adjacent to the proximal end of the linking component and viewable in at least one of a tomography imaging scan and a surface imaging scan.

2. The dental device of claim 1, wherein the proximal end of the linking component includes a fastening head.

3. The dental device of claim 2, wherein the fastening head is a screw head.

4. The dental device of claim 3, wherein the screw head has a frustoconical shape.

5. The dental device of claim 1, wherein the marker is one of integral with the proximal end of the linking component and releasably engagable with the proximal end of the linking component.

6. The dental device of claim 5, wherein the releasably engagable marker has at least one of a snap, a screw, and a tap-in attachment mechanism configured to engage the proximal end of the linking component.

7. The dental device of claim 1, wherein the marker is made at least partially of a radio opaque material.

8. The dental device of claim 1, wherein the marker is at least one of a radiodensity comparative reference marker and a negative marker.

9. The dental device of claim 1, wherein the marker is positioned adjacent to a portion of gum tissue.

10. A system for performing a dental procedure comprising:
a dental device having a linking component and a marker engaged with the linking component, wherein the dental device is viewable in a tomography imaging scan;
a tomography imaging scan of the mouth to create a tomography scan data set; and
a surface imaging scan of the mouth to create a surface scan data set, wherein the tomography scan data set and the surface scan data set may be aligned using an image of the dental device represented in the data sets.

11. The system of claim 10, wherein the marker is used to orient and verify data from the tomography scan data set and the surface scan data set to create a master data file.

12. The system of claim 11, wherein the master data file is used to create one of a digital diagnostic model and a physical diagnostic model.

13. The system of claim 10, further comprising a digital design of the dental device modeled from the surface scan data set.

14. The system of claim 13, wherein the digital design is used to align data from the tomography scan data set and the surface scan data set to create a master data file.

15. The system of claim 14, wherein the master data file is used to create one of a digital diagnostic model and a physical diagnostic model.

16. A dental device comprising:
a linking component having a proximal end and a distal end, the distal end configured to penetrate at least one of an oral structure and a model of an oral structure; and
a marker disposed on the proximal end of the linking device, wherein the marker is positioned adjacent to at least one of a portion of gum tissue and a model of gum tissue and is viewable in at least one of a tomography imaging scan and a surface imaging scan.

17. The dental device of claim 16, wherein a pickup coping is disposed on the proximal end of the linking component

18. The dental device of claim 17, wherein the pickup coping is embedded in a dental impression.

19. The dental device of claim 17, wherein the pickup coping is used to accurately transfer the orientation and positioning of the dental device to a physical dental model.

20. The dental device of claim 16, wherein the proximal end of the linking component is configured to receive a dental appliance.
